(19) United States
(12) Patent Application Publication
(10) Pub. No.: US 2014/0040136 A1
(43) Pub. Date: Feb. 6, 2014

(54) Government wide commercial transportation shipping debit card and smart phone application

(71) Applicant: Doris Schueler Gatlin, San Antonio, TX (US)

(72) Inventor: Doris Shueler Gatlin, San Antonio, TX (US)

(73) Assignees: William F. Ryann, San Antonio, TX (US); Doris Shueler Gatlin, San Antonio, TX (US)

(21) Appl. No.: 13/987,453

(22) Filed: Jul. 27, 2013

Related U.S. Application Data
(60) Provisional application No. 61/676,918, filed on Jul. 28, 2012.

(51) Int. Cl. G06Q 50/26; G06Q 20/40

(52) U.S. Cl. CPC G06Q 50/26; G06Q 20/4037
USPC 705/44

(57) ABSTRACT

A method for monitoring government Transportation Account Codes funding by providing mechanisms to verify shippers identity, schedule shipments of different types, schedule other TAC usages, approve and disapprove shipment funding according to the TAC funding availability. The system includes a Demilitarized zone for external access to the system while keeping the system protected internally. The system allows for an extensive reporting mechanism of all TAC activities. The system uses smart devices to implement control even when arranging shipments off-premises. The system allows Carriers to interact with the environment to confirm shipment pick up. The system allows for Internal and external tasking. The system allows a Fund Manager to add funding as necessary to facilitate government activities. The system results in saving the government wasted funding while providing efficiency and control.

### FIELD OF THE INVENTION

The invention relates to a method for allowing government agencies to monitor and control transportation and shipping transactions involving the transfer of goods and/or services for official government use worldwide. The method provides monitoring tools for government transportation expenditures, to eliminate abuse and save funding resources.

### BACKGROUND OF THE INVENTION

A government agency uses TACs (Transportation Account Codes) to pay for funded cargo and personal property shipments throughout the agency such as Defense Transportation System (DTS). TACs are four-character pointers to a Line of Accounting (LOA) that identify the appropriation or user ultimately responsible for the associated transportation costs.

TACs were created because the Transportation Control Movement Document (TCMD) only had four available positions to represent the LOA. Additionally, manually typing the 50 to 65 character LOA into Bills of Lading (BL) resulted in high error rates, which led to major delays in paying Transportation Service Providers (TSPs) who provided transportation services. The decision to use TACs for cargo and personal property movements has resulted in fewer errors and facilitated the use of electronic payment processing. TACs are inherently financial in nature, requiring a partnership between the transportation and financial communities to ensure appropriate usage, accurate LOAs are properly associated to TACs, and sufficient funds are obligated to meet projected transportation costs. Inappropriate use of TACs, errors in LOAs, and not monitoring TAC expenditures result in an adverse operational impact on soldiers and units, increased Defense Finance and Accounting Service (DFAS) payment processing and interest charges, and potential Anti-Deficiency Act (ADA) violations. As a consequence, all Army organizations must routinely monitor their usage of TACs. Monitoring remained largely manual and virtually impossible.

### BRIEF SUMMARY OF THE INVENTION

It is an objective of this invention to provide:

A method of monitoring TACs usage and expenditures. Such method allows government official to control the usage or TACs, automatically verifying funds availability, scheduling and confirming shipment through a close relationship between shippers and commercial carriers.

The present invention includes a set of hardware and software distributed internally and externally in a DMZ.

The present invention provides a demilitarized zone to allow shippers to schedule shipment while off-premises using a smart device.

The present invention provides multiform employee/shippers authentication for a secure access management.

The present invention provides means to allow employees to pre-register in the monitoring system to obtain shipping capability.

The present invention provides means to schedule shipments in the TAC monitoring system, through an intranet web form or through a smart device.

The present invention provides means to ship on premises or off premises, while allowing carriers to confirm receipt of shipment.

The present invention includes capabilities to automatically compute shipment cost or to allow carriers to enter cost, and automatically verify funding availability to approve or not approve a shipment.

The present invention provides means to alert a fund manager of a lack of funding for further allowances.

The present invention provides means to submit an un-approved shipment for further processing after fund manager has allocated additional funding.

The present invention provides instant TAC reporting capability.

In accordance with the above, the Government Wide Commercial Transportation Shipping Debit Card and Smart Phone System supports total monitoring of TACs and expenditures by keeping track of all shipments that have been made, with complete information of shipper identity, location of shipments, cost of shipment, status of shipment, that is approved/unapproved, in process or confirmed, confirmed, working in conjunction with DFAS and GFEBS to increase electronic payment system efficiency and accuracy.

### BRIEF DESCRIPTION OF THE DRAWINGS

FIG.1 is a schematic of the TAC Monitoring System Building block

FIG. 2 is a view of the hardware relation between the DMZ and the Intranet.

FIG. 3 is a view of the equipment distributed between the DMZ and the Department Intranet.

FIG. 4 is a view of the logic used to allow a smart device user to connect to the DMZ system

FIG. 5 is a view of the user registration form to be assigned a shipper role.

FIG. 6 is view of the logic for a smart device user to schedule a freight shipment

FIG. 7 is a view of the logic to schedule a freight shipment through an intranet form

FIG. 8 is a view of the logic used in shipping and confirming receipt of a shipment, from government premises.

FIG. 9 is a view of the logic used in shipping and confirming receipt of a shipment, from off government premises.

FIG. 10 is a view of the logic used to instantly check for TAC funding availability, in a real time situation, with multiple consecutive TAC shipments scheduled.

FIG. 11 is a view of the logic used to re-approved a previously un-approved shipment schedule

FIG. 12 is a view of the logic used to schedule a shipment with multiple TACs such as involving OCONUPS or overseas shipment with multiple ports of entry and ports of destination worldwide

FIG. 13 is a view of the integration of the TAC monitoring system, carrier invoicing and GFEBS.

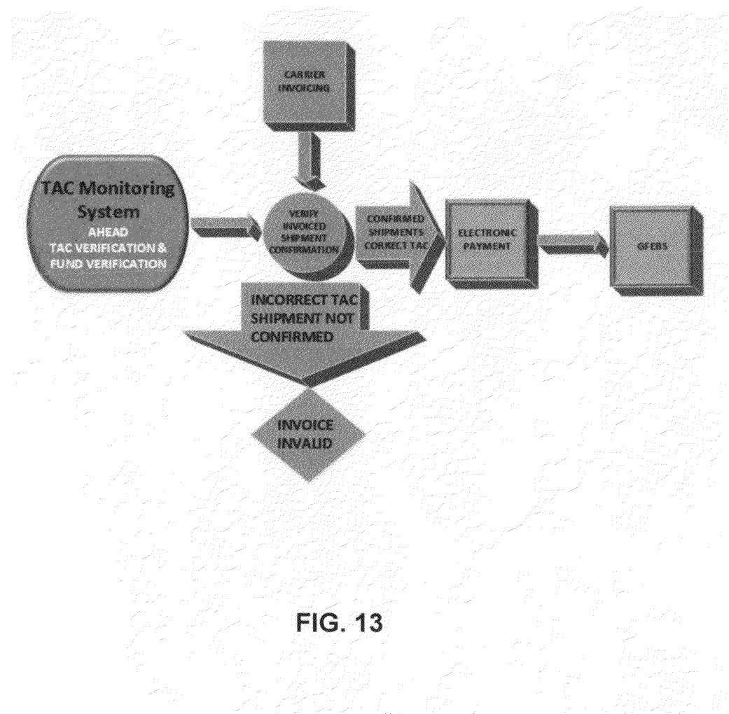

### DETAILED DESCRIPTION OF THE INVENTION

Description of the Government Wide Commercial Transportation Shipping Debit Card and Smart Phone application

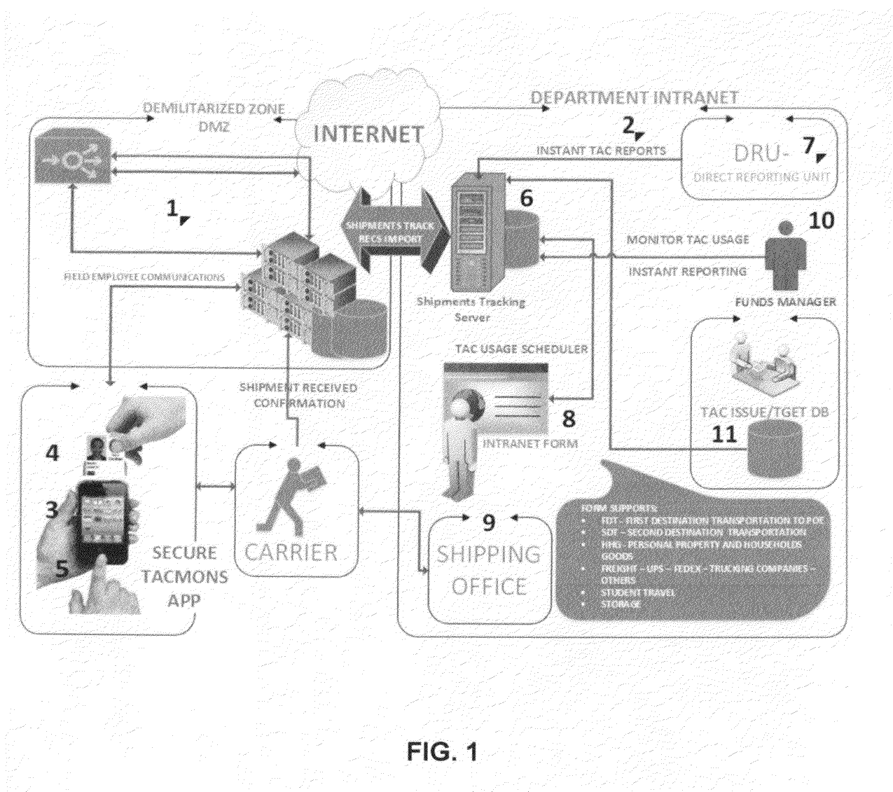

FIG. 1 schematically illustrates the elements of the TAC Monitoring System, which equipment are distributed between a DMZ, 1, and the department intranet, 2. The system allows off premises government users to use their smart device, 3, outfitted with a PIV/CAC Card reader, 4, and a biometric reader, 5. To login to the DMZ, a user slides his PIV/CAC badge into the card reader slot and placing the appropriate thumb on the biometric reader so that a fingerprint match on card is instantly performed allowing the smart device to open, extract the user email from the CAC/PIV card authentication certificate to be transmitted to the server located at the DMZ, whereas the server checks the pre-registered shippers database to locate the user record, extracts a secret question to be transmitted to the smart device. After the user has entered the secret answer and the system has verified the answer to be correct, the smart device opens the TAC App. The TAC app is set of icons dedicated to a certain function:
Enter/schedule a shipment
Get a list of approved shipments/select and ship
Re-approve previously un-approved shipment
Schedule multi-TACs shipments
Schedule HHG shipment
Schedule Storage
Student Travel
Others . . . .

After scheduling, a shipment can be shipped by opening the Shipping App, selecting a shipment icon, and touching the icon. The app displays a 1D barcode including a shipment ID, such barcode is read by the carrier TAC app, which transmits a shipment received confirmation message to the DMZ. With the shipment completed, the shipment record is moved to the internal database and removed from the DMZ database, 6. The TAC shipment database is used by the DRU (Direct Reporting Unit), 7, to continuously obtain TACs reports, instantly, including the latest information about completed and approved shipments. An internal form, 8, provides the same capabilities as the smart device app, to allow shippers to perform all systems functionalities internally without the need for a smart device.

The Internal shipping office, 9, could act as a shipping endpoint for a shipment, whereas a shipping office personnel would initiate the shipment received confirmation message.

In case of unavailable TAC funding, the system logs the shipment scheduling information, flags it as unapproved, and emails the TAC Funds Manager, 10, to report TAC funding request. Once the request has been approved and TAC funding has been arranged, the Fund Manager emails back the shipper about the new TAC fund availability. At that time, a shipper can access the re-Approve app or form, to get a shipment approved.

TAC data are initially driven from the TAC ISSUE/TGET Database, 11.

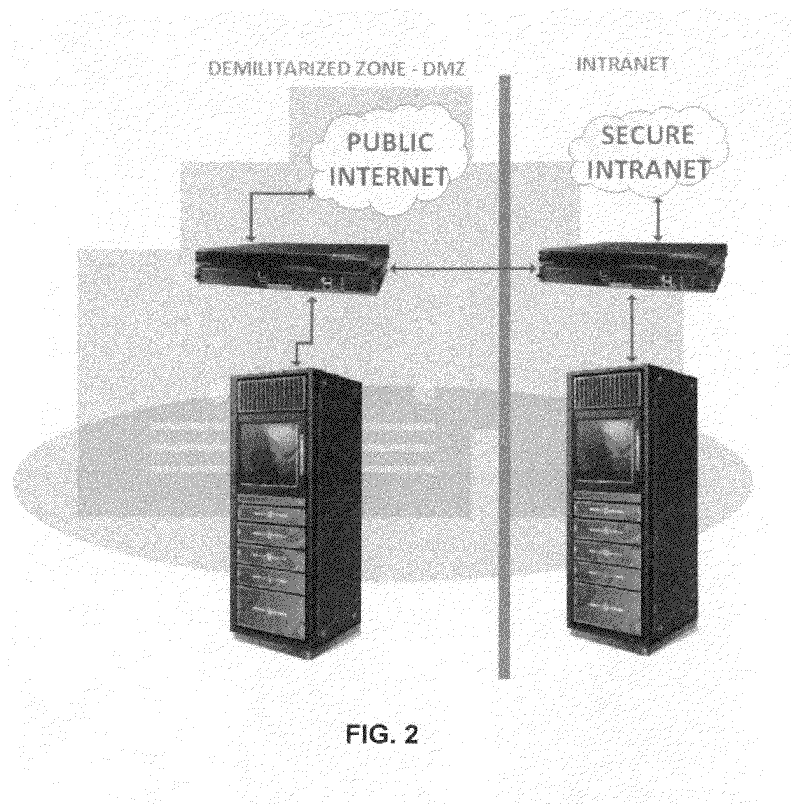

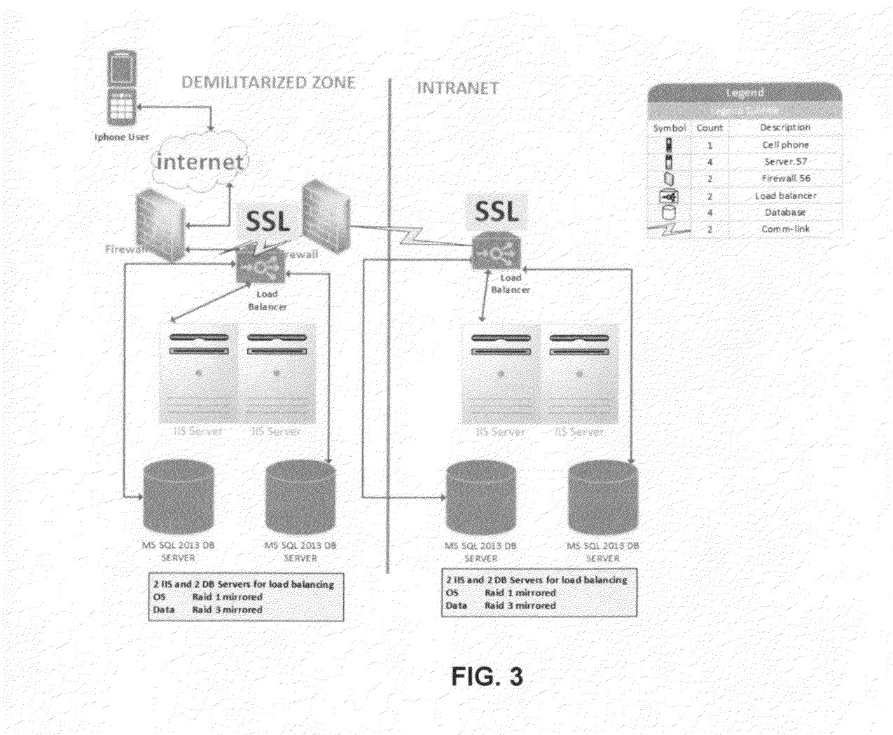

FIGS. 2 and 3. Illustrate the Department DMZ area and the Intranet area connected through a firewall. Application servers use the SSL protocol to encrypt all communications between the user and the server, for a secure process. In addition, the system includes redundancy and load balancing features for an improved response time.

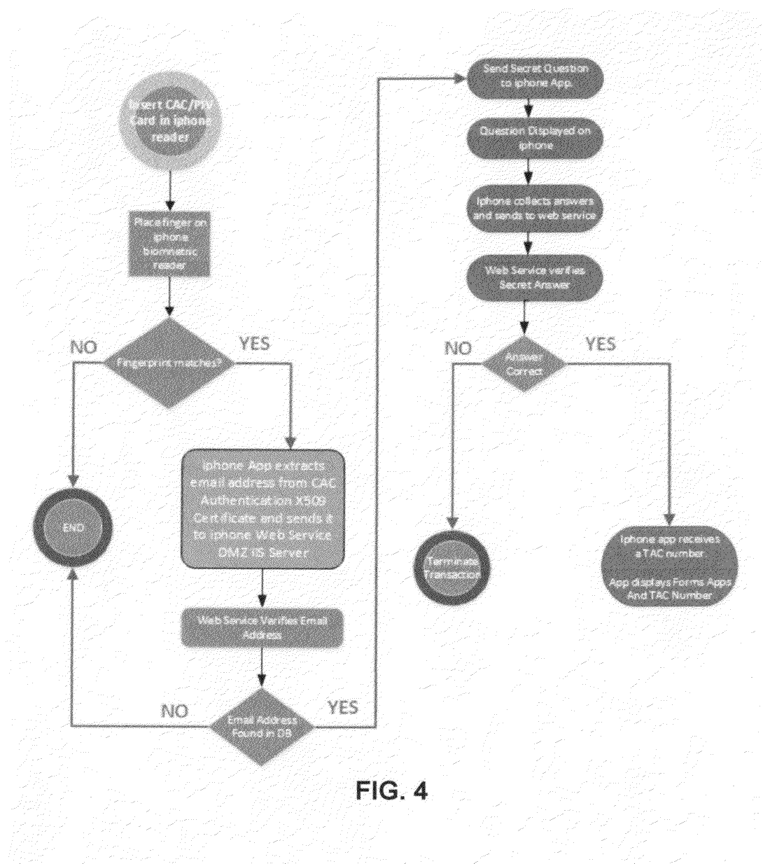

FIG. 4. Illustrates the secure communication established between a smart device and the DMZ server. To secure this communication, the system uses a multifactor authentication process where as a shipper uses a government badge and a thumb to match between the thumb fingerprint and the badge smart chip fingerprint content. In case of a match, the smart device extracts the email from the badge authentication X.509 certificate and sends it to the DMZ server. The server matches the email with the shipper pre-registration database to determine the identity of the shipper and extracts shipper credentials. With the shipper identified, the server sends one of the secret questions to the smart device to be displayed for the user. Upon answering the secret question, the smart device relays the data to be verified by the server. Upon successful verification, the server provides the smart device with the user TAC and instructs the device to proceed with allowing user action.

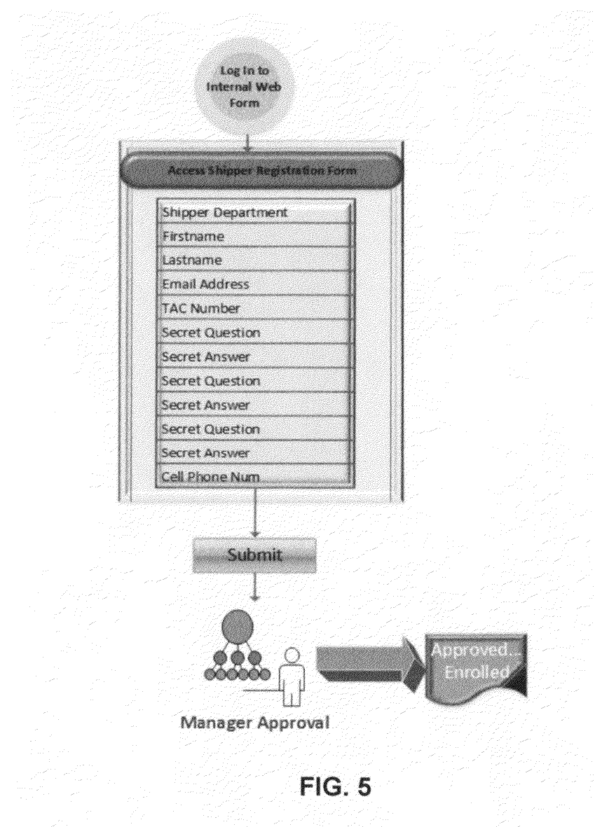

A pre-registration form, as illustrated in FIG. 5, and which can only be initiated internally, allows the system to store shipper data such as:
Shipper Department
First and last name
Email address
TAC Number
A set of Secret Questions and answers
Cell phone number

The pre-registration is further approved by the Shipping Manager to complete the user enrollment as a shipper.

With this information in the database, the user needs not to remember a TAC number as the authentication process automatically provides the number upon matching the user.

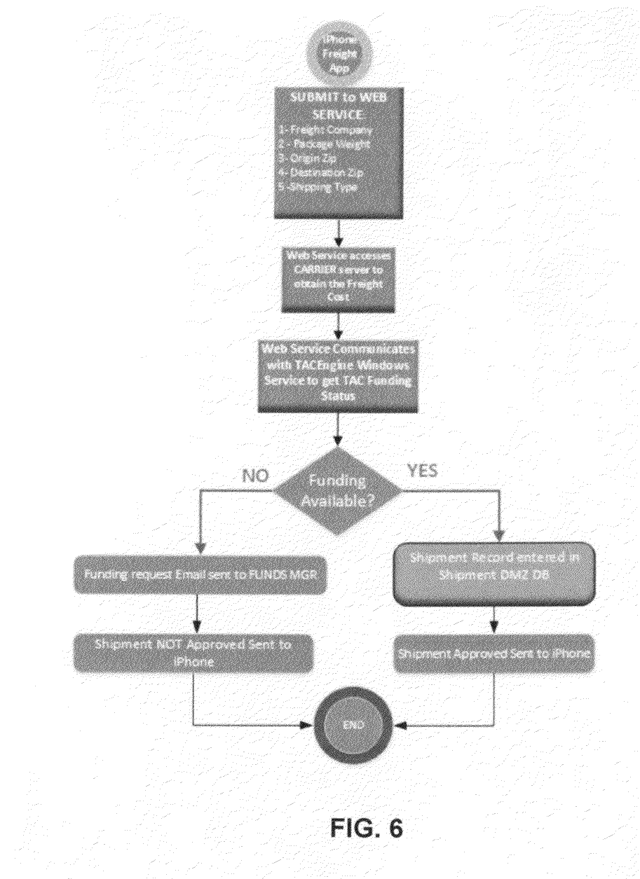

FIG. 6. Illustrated the shipper freight request process, through a smart device, whereas freight data are entered, such as:
Package weight
Ship from Zip code
Ship to zip code
Carrier used
Type of shipment

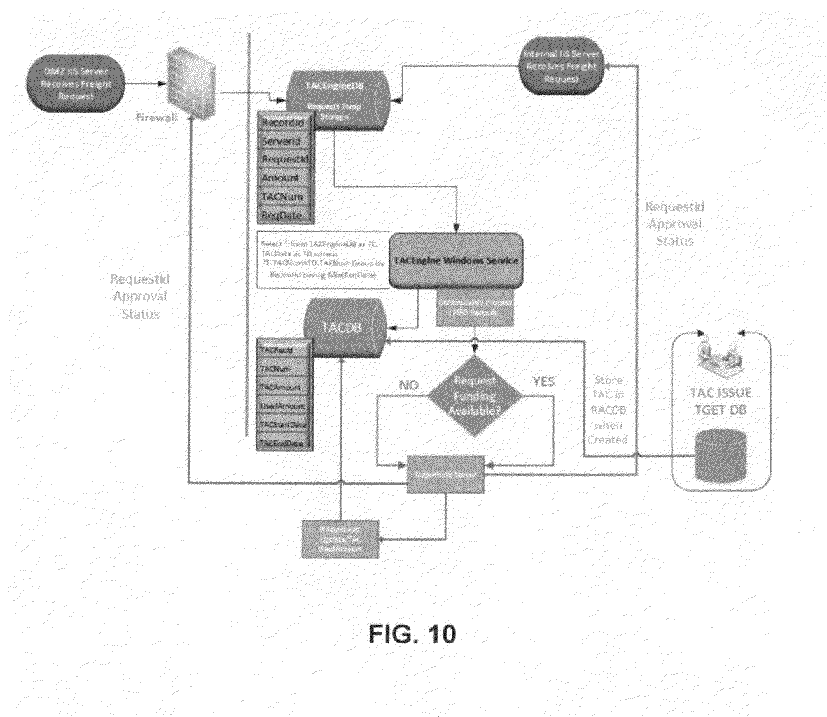

The smart device transmits the form data to the DMZ server. With the shipment data collected, the server connects to the carrier web service and extracts shipping cost information. Having the cost information, the server provides the TAC number and requested fund to the TACENGINE Service as illustrated in FIG. 10. The TACENGINE service continuous task is to receive incoming TAC funding requests, schedule request for fund verification on a first come first serve basis, and instantly provide fund/shipment approval to the requesting server. The requesting server provides the final status to the smart device and logs the shipping record in the DMZ database, whereas such record is flagged as “Approved” or “Un-Approved” depending on TAC funding availability. In the case of unavailability, the server emails the detailed request to the Funding Manager to approve additional funding.

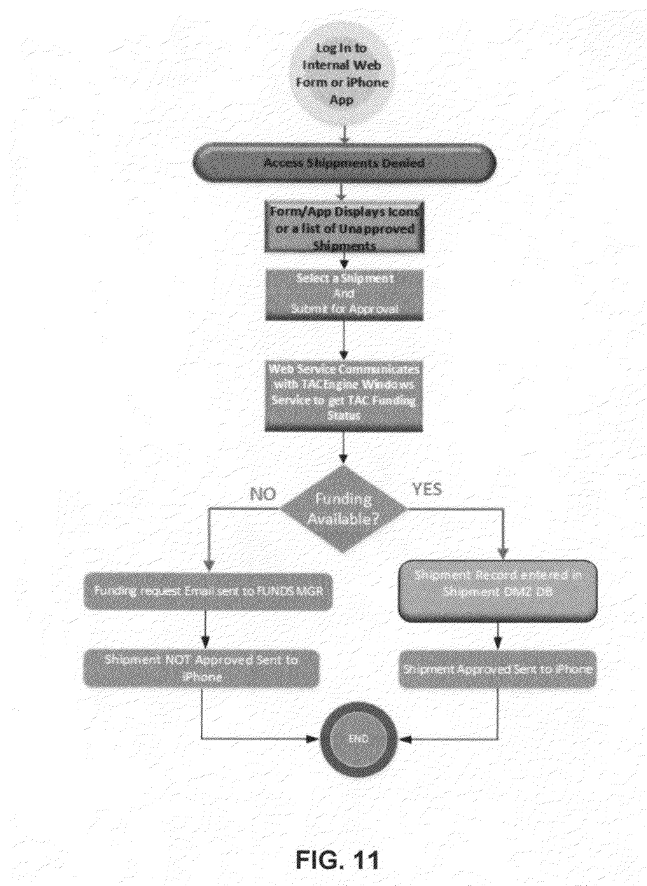

Upon approving additional TAC funds, the shipper receives a notice and proceed with initiating the Shipment Re-Approval process, as illustrated in FIG. 11.

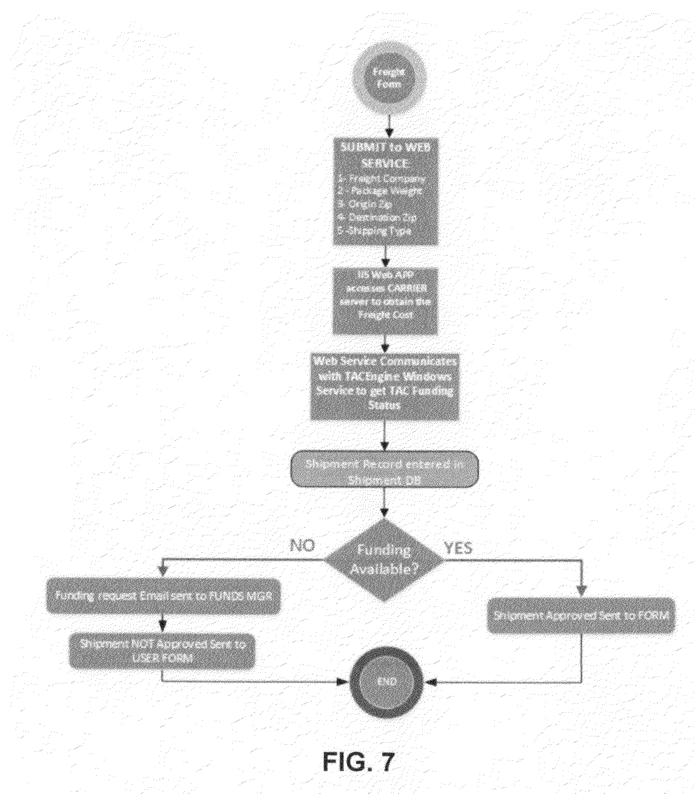

Intranet Freight requests, illustrated in FIG. 7, and re-Approval can be performed internally in the same manner using an Intranet web form.

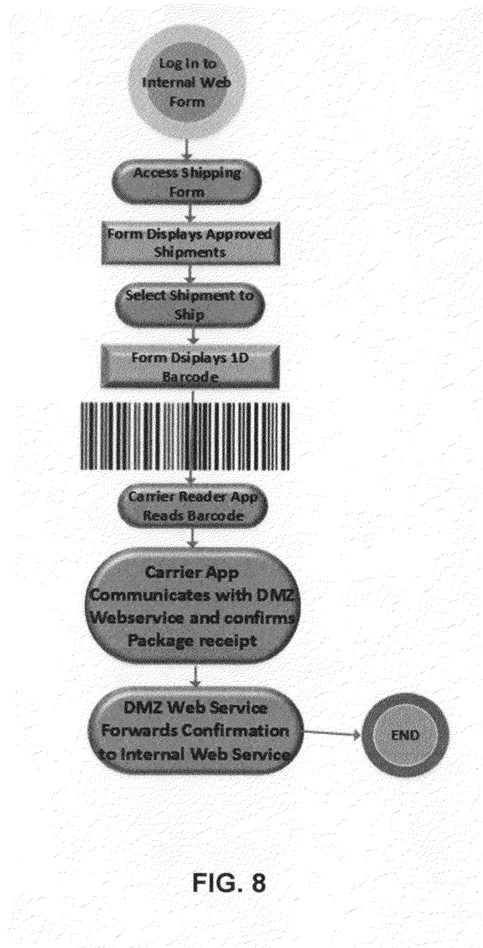

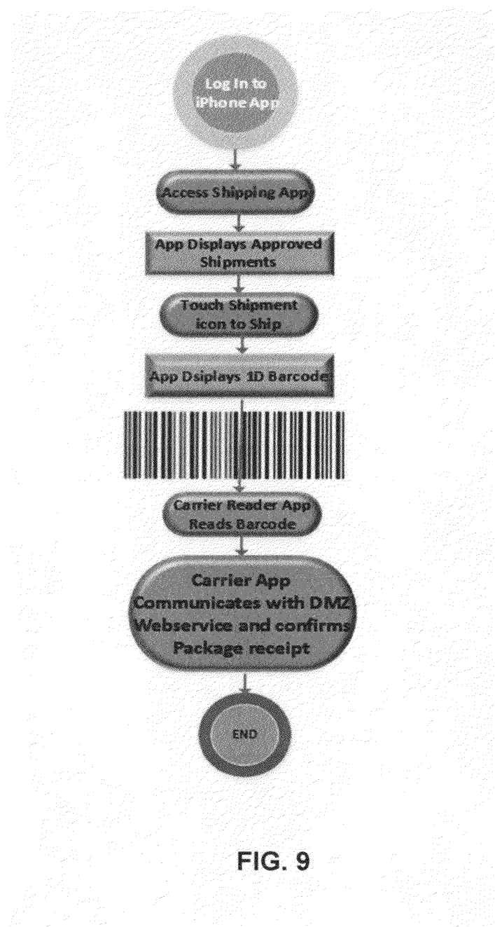

As illustrated in FIG. 8 and FIG. 9, packages can be carrier picked up at any location using the smart device shipping app or web form. When a shipment is picked up by the Freight carrier, the shipper logs the shipment as picked up. The smart device or web forms, instantly displays a shipping 1D barcode the includes a shipment ID, whereas the Freight Carrier reader is able to read the code and transmits a shipment picked up confirmation message to the DMZ server. With that message, the shipment is completed and the shipment record is moved to the internal database for reporting purposes.

Shipments or other TAC usages that do not allow the server to automatically determine the cost of TAC usage involved, will be scheduled in the service as unapproved and a request emailed to the carrier for cost estimate. A carrier is provided with an App to allow entry of the cost estimate. Once the cost estimate is entered, the Server communicates with the TACENGINE to verify fund availability whereas the validation process continues in the same manner as stated above for the Freight shipment.

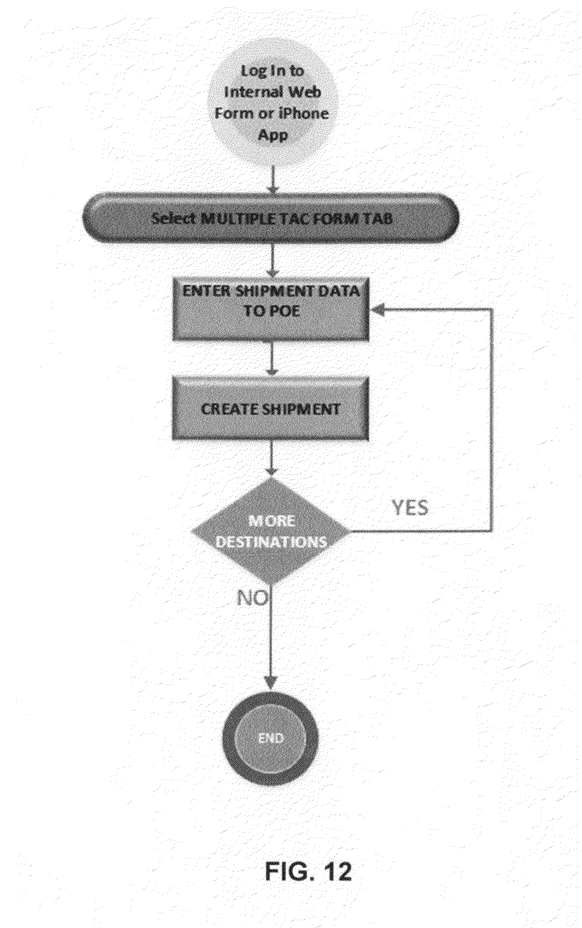

TAC shipment, especially involving outside the Continental United States shipments, may require usage of multiple TACs whereas each portion of the freight is covered by a different TAC. FIG. 12 illustrate the process used to manage those shipments whereas multiple interrelated records are created for one shipment. However, those records, once created, are each managed as if it was a single shipment, with a confirmation message received after the end of each shipment portion.

The TAC monitoring system as detailed above integrates well with existing environment whereas the ATC Monitor system allows accounting to verify carrier invoicing for completed shipment, rejects Invalid invoices, and accelerates the payment processing so as to eliminate disbursement problems and avoid banking fees.

What is claimed:

1. A System to monitor TAC funding and report funding availability comprising: a secure area including one or more central processing unit, and one or more storage system unit whereas freight requests are received from off premise sources a smart device including a smart media reading means and a biometric reading means whereas the device is authenticated into the secure area computer system and includes a software application wherein the smart device software application transmits freight requests to the secure area server, said server determines freight charges and transmits requests to a processing unit that determines TAC funding availability and returns an approval or denial message depending on funding availability.

2. A System to monitor TAC funding and report funding availability comprising: a secure area including one or more central processing unit, and one or more storage system unit whereas freight requests are received from a web application accessible from the intranet wherein the web application transmits freight requests to the server, said server determines freight charges and transmits requests to a processing unit that determines TAC funding availability and returns an approval or denial message depending on funding availability.

3. The method of claim 1 whereas the smart device uses multi factor authentication to identify users, such authentication uses a PIV/CAC employee badge, fingerprint reading to be matched against the PIV fingerprint and a secret question and answer verification process to uniquely identify a user.

4. The method of claim 1 whereas a user performs a pre-registration into the system providing the TAC number, secret questions and answers, a unique identifier allowing the system to uniquely identify the user.

5. The method of claim 2 whereas a user performs a pre-registration into the system providing the TAC number, secret questions and answers, a unique identifier allowing the system to uniquely identify the user.

6. The method of claim 1 whereas a demilitarized area is used to secure external communication and establish communication with the internal network.

7. The method of claim 1 whereas the system accepts multiple TAC shipments accounting for each portion of the shipment as a single point to point shipment.

8. The method of claim 2 whereas the system accepts multiple TAC shipments accounting for each portion of the shipment as a single point to point shipment.

9. The method of claim 2 whereas the system integrates with the existing General Fund Enterprise Business System.

10. The method of claim 2 whereas carrier invoicing is verified within the system storage as being a confirmed shipment.

11. The method of claim 1 whereas the user gets a display of icons on the smart device with each icon representing a scheduled shipment, whereas once a user touches the icon when the shipment is picked up, the smart device displays an automated media containing the shipment unique ID, and whereas the carrier device can read the media and the device app is able to confirm to the DMZ server that the shipment was picked up.

12. The method of claim 2 whereas the user gets a list of scheduled shipments, whereas once a user selects a shipment while it is picked up, the internal network web form displays an automated media containing the shipment unique ID, and whereas the carrier device can read the media and the device app is able to confirm to the Internal or DMZ server that the shipment was picked up.

13. The method of claim 1 whereas when TAC funding is unavailable the shipment is not approved but is logged in the database, whereas a communication is sent to the Funds manager for additional funding, whereas once the funding is approved, the user can resubmit the shipment for approval.

14. The method of claim 2 whereas when TAC funding is unavailable the shipment is not approved but is logged in the database, whereas a communication is sent to the Funds manager for additional funding, whereas once the funding is approved, the user can resubmit the shipment for approval.

15. The method of claim 2 whereas the Direct Reporting Unit is able to view TAC activity and obtain TAC Usage reports instantly.

16. The method of claim 1 whereas the system supports all TAC usages, including Personal property and Household goods movement, student travel, storage, and all carrier shipments.

17. The method of claim 2 whereas the system supports all TAC usages, including Personal property and Household goods movement, student travel, storage, and all carrier shipments.

18. The method of claim 2 whereas a central processing unit is dedicated to receive TAC funding requests, verify each request on a first in first serve basis, and whereas a funding approval decision is transmitted back to the request originating server and whereas TAC information are extracted from the TGET database on a regular basis, and stored in the central processing unit database whereas the TAC original fund amount and the TAC usage amount are updated to keep track of TAC funding activities.
